(19) United States
(12) Patent Application Publication
(10) Pub. No.: US 2024/0297532 A1
(43) Pub. Date: Sep. 5, 2024

(54) METHOD FOR INDUCTIVE ENERGY TRANSMISSION

(71) Applicant: B&R INDUSTRIAL AUTOMATION GMBH, Eggelsberg (AT)

(72) Inventor: Andreas KREINDL, Eggelsberg (AT)

(73) Assignee: B&R INDUSTRIAL AUTOMATION GMBH, Eggelsberg (AT)

(21) Appl. No.: 18/567,986

(22) PCT Filed: Jun. 7, 2022
(86) PCT No.: PCT/EP2022/065316

§ 371 Date: Dec. 7, 2023

(30) Foreign Application Priority Data
Jun. 8, 2021 (AT) A 50460/2021

(51) Int. Cl. H02J 50/12; B60L 53/122; H02J 50/80; H02K 41/03

(52) U.S. Cl. CPC H02J 50/12; H02J 50/80; B60L 53/122; H02K 41/031

(57) ABSTRACT

A method for inductive energy transmission between a primary part and a secondary part, wherein a primary current is introduced into a transmitting coil arranged on the primary part in order to create a first magnetic field which induces an electrical AC voltage in a receiving coil arranged on the secondary part, which electrical AC voltage causes an electrical secondary current at the secondary part and thus a power flow to at least one load connected to the receiving coil, which power flow comprises an uncompensated active power, it is provided that a compensation unit introduces a compensation current into a secondary-side coil, which compensation current generates a second magnetic field which is superimposed on the first magnetic field and induces a compensation voltage in the transmitting coil. The compensation voltage changes the phase shift between the primary voltage that drops across the transmitting coil and the primary current flowing through the transmitting coil in such a way that the transmitted active power is increased.

The present invention pertains to a method for inductive energy transmission between a primary part and a secondary part, wherein an electrical primary current is fed from a supply unit into a transmitting coil arranged on the primary part in order to create a first alternating magnetic field for energy transmission, whereby an electrical AC voltage is induced in a receiving coil arranged on the secondary part, which electrical AC voltage causes an electrical secondary current at the secondary part and thus a power flow comprising an uncompensated active power to at least one load connected to the receiving coil.

Methods for contactless energy transmission play an important role in a large number of technical applications. Charging systems for electric cars and transport systems in the form of linear or planar motor systems in which moving components have to be supplied with electrical energy are only a few examples. Advantages thereof, compared to conductive energy transmission systems, are, in particular, an often more compact design which is often made possible by the omission of cables and plugs, a higher robustness associated therewith, and a frequently longer life due to a reduction of wear parts. Although contactless energy transmission systems have been known for a long time, in particular the ongoing requirements for higher efficiency and lower losses continuously lead to new technological problems.

An object essential in this context that is particularly important in transport systems is the realization of efficient and low-loss contactless energy transmission that takes into account feed and transmission limitations. In this case, feed and transmission limitations often result from physical limits of power electronic devices, in particular if they are arranged in supply units for the electrical supply of energy transmission systems. Examples of physical limits in this respect are primarily limited intermediate circuit voltages and thus limited supply voltages, limited electrical currents based on an often limited thermal load-bearing capacity and electromagnetic effects, such as the skin or proximity effect. A direct consequence of a limited supply voltage in combination with a current that is permissible only to a limited extent is a limitation of the available electrical (supply) power, which can limit the delivery of electrical energy from a supply unit to an energy supply system.

In order to achieve said object, the concept of “resonant coupling” is often applied in the prior art. To that end, in the case of inductive energy transmission, the transmitting and receiving coils provided are typically connected to capacitive energy stores in the form of capacitors. The interconnection of transmitting and receiving coils with capacitors produces, on the one hand, an oscillating circuit, and, on the other hand, a resonant electrical circuit results from the combination of the resonant circuits. The usual goal of a resonant coupling is, at this point, to select the frequency of the supply voltage applied to the transmitting coil, which is often referred to as the excitation frequency, to be as equal as possible to a resonance frequency of the resonant electrical circuit. In particular, the magnetic coupling between transmitting and receiving coils is thereby increased, whereby an efficient and low-loss energy transmission can often be brought about.

In the case of the aforementioned transport systems, for example in the form of a linear motor system, a planar motor system or a magnetic levitation railroad system, the implementation of a resonant coupling is often significantly more difficult, however, in particular due to the fact that relative movements between the components involved in the energy transmission are not only possible during operation, but are usually even the rule. Such relative movements significantly influence the resonance frequencies of an energy transmission system in a variety of ways. Due to the fact that a resonant coupling typically requires precise and highly exact tuning between the excitation frequency and the resonance frequency, shifts of resonance frequencies in many cases can have an extremely negative effect on the amount of energy ultimately transmitted.

In this context, stationary components of a transport system are often referred to as “primary parts,” whereas the designation “secondary parts” is typical for components of a transport system that are movable relative to a primary part. In particular in linear motor technology, electrical and/or electronic components for which a corresponding electrical power supply must be provided are increasingly arranged on the movable secondary parts. Since, on the one hand, batteries on and in the secondaries are often undesirable, and, on the other hand, conductive energy transfer for supply is often not feasible, the question of contactless energy transfer is of great importance, especially in linear and planar motor systems, which additionally should be low-loss and efficient, despite difficult conditions due to possible relative movements between the primary and secondary parts. The known prior art also reflects this circumstance.

For example, U.S. Pat. No. 7,958,830 B2 describes an inductive energy transfer for a linear motor from a fixed primary part to a secondary part that can move relatively to it. It is noted that the circuit for receiving energy on the secondary part is set such that a maximum energy is coupled, wherein it is not explained what this setting means specifically, for example in relation to a possible tuning of an excitation frequency with a resonance frequency.

In contrast, EP 2793356 B1 and EP 2903407 A1 also disclose a capacitive energy transmission for linear motors from a static primary part to a secondary part movable relative thereto, for which purpose both the primary part and the secondary part are equipped with electrode plates. In both publications, the electrode plates serve to build up an electrical field between the primary part and the secondary part, through which the desired energy transmission takes place. Similar to U.S. Pat. No. 7,958,830 B2, EP 2793356 B1 describes a tuning of the electrical components involved in the energy transmission to bring about a minimum impedance of the electrical circuit which is formed by the electrical components involved, wherein, however, no details on performing this tuning are specified here.

The concepts disclosed in the cited publications have several disadvantages in practical implementation. In the case of capacitive energy transmission, above all the required installation of additional electrode plates is to be assessed critically in this context. In many cases, the associated additional hardware outlay cannot be implemented in a justifiable manner. In addition, particularly electromagnetic disturbances often are an undesirable consequence of capacitive energy transmission systems, which often make their use more difficult and sometimes even prevent it. Not least for these reasons, the present invention is directed to inductive power transmission systems.

A further disadvantage of known methods both for capacitive and inductive energy transmission results in transport systems as mentioned from the fact that relative movements typically occur between a supplying primary part and a supplied secondary part. As a result, the transmission and coupling relationships between the components of an energy transmission system can change, which, among other things, can result in a shift of the electrical resonance frequencies of the energy transmission system. If the contactless energy transmission in this context is based on a resonant coupling, for obvious reasons the excitation frequency must be adapted to resonance frequencies that in some cases are changing. Such an adaptation is not disclosed in the prior art. In addition to relative movements between the primary and secondary parts, heating, aging, wear and nonlinear properties of electrical components can also cause changes in the transmission conditions, which additionally increases the need for a suitable adaptation mechanism.

Another important problem in this context, that is not taken into account in the prior art, relates to the type of transmitted energy or power. For obvious reasons, only transmitted active power provides a lasting contribution to supplying a load arranged on a secondary part of a transport system. In the course of an inductive energy transmission, by contrast, the reactive power transmitted always oscillates back and forth exclusively between energy stores present in the energy transmission system and therefore does not contribute to a usable supply of a load. The focus of efficient inductive energy transmission accordingly is to be primarily directed toward the transmitted active power, which in the prior art often is not the case to a sufficient extent.

In the case of linear and planar motors, the aforementioned problems are often intensified in practice by the requirement to avoid the additional expenditure in terms of components and costs associated with an installation of separate transmitting coils for inductive energy transmission. Frequently, already existing drive coils for forming a drive force between a primary and a secondary part are therefore additionally used as transmitting coils for inductive energy transmission. However, these coils typically have a large leakage inductance which is caused in particular by a large air gap compared to other applications of inductive energy transmission. In this context, those portions of the transmitting and receiving coil that generate a magnetic flux which does not pass through the other coil and accordingly have only a self-induction effect are referred to as leakage inductances. As is well known, a so-called main inductance is in contrast that part of both coils which generates a magnetic flux passing through both coils, thus having a self-induction as well as a mutual induction effect, and thus bringing about the coupling of the primary and secondary part necessary for an inductive energy transfer. With regard to the present energy transmission, large leakage inductances are disadvantageous for several reasons. In particular, they increase the reactive power that occurs, which directly reduces the transmittable active power, especially in the case of a supply voltage or supply power, which is available only to a limited extent.

If a transmitting coil is to be used to transmit energy and generate drive force at the same time, this usually takes place by superimposing low-frequency currents, which are fed into the drive coils in order to form a drive force and are therefore also referred to as drive currents, onto currents that are higher frequency than said low-frequency currents and bring about the desired energy transmission. If the available supply voltage is limited in such a case and a large portion is already used by this limited supply voltage to form currents for force generation, it can be seen that the remaining voltage reserve has to be used optimally for transmitting active power.

It is therefore an object of the present invention to improve the contactless and in particular inductive energy transmission between a primary part and a secondary part of a transport system that is movable relative thereto. The aim is to minimize additional hardware requirements, enable robust and reliable adaptation to changing transmission conditions during operation and, in particular, optimize the transmitted active power.

This object is achieved according to the invention by the features of the independent claims. Specifically, a system for inductive energy transmission between a primary part and a secondary part is assumed, in which system an electrical primary current is fed by means of a supply unit into a transmitting coil arranged on the primary part, which electrical primary current brings about a first alternating magnetic field for energy transmission which induces an electrical AC voltage in a receiving coil arranged on the secondary part and thereby brings about a current flow and thus a first power flow to at least one load connected to the receiving coil. With regard to the first power flow, it is true that this would also occur without applying the method according to the invention described below, but would only transport a so-called nominal active power. Such a nominal active power is also referred to below as “uncompensated” active power.

Essentially, the present invention provides for such a system, by means of a compensation unit arranged on the secondary part, to feed a secondary-side compensation current into the secondary-side receiving coil or into a possibly further coil arranged on the secondary part. The purpose of the secondary-side introduction of compensation current is to generate a second alternating magnetic field which induces a compensation voltage in the transmitting coil on the primary part, which compensation voltage changes the phase shift between the total voltage dropping across the transmitting coil and the current flowing through the transmitting coil. According to the invention, the change in this phase shift takes place in such a way that the active power transmitted from the primary to the secondary part during the energy transmission is increased. This procedure takes into account the fact that the active power transmitted to a load on the secondary side is of particular importance for the supply of this load.

According to the invention, it is provided that no primary-side compensation current which changes the phase shift between the electrical primary voltage dropping across the transmitting coil and the primary current flowing through the transmitting coil is fed into the transmitting coil arranged on the primary part, which primary-side compensation current is provided by an electrical storage element connected in series with the transmitting coil and between the supply unit and the transmitting coil. Capacitors are preferably used as electrical storage elements for providing a compensation current. A capacitor connected in series with the transmitting coil would, however, prevent the introduction of a direct current into the transmitting coil. For this reason, the omission of storage elements connected in series with the transmitting coil allows for electrical DC quantities, such as an electrical direct current, to also be set in the transmitting coil.

In a particularly advantageous manner, the phase shift between the primary current dropping across the transmitting coil and the primary current flowing through the transmitting coil is changed only, i.e., exclusively, by the primary-side compensation voltage caused by the secondary-side compensation current and induced in the transmitting coil. In this case, electrical storage elements for providing a compensation current are completely omitted on the primary side, which also includes omitting energy storage elements connected both in series with and parallel to the transmitting coil.

The possibility of also supplying a transmitting coil with direct current via the supply unit is decisive in particular when using the present energy transmission system in transport systems, such as in the case of a linear motor system, a planar motor system or a magnetic levitation railroad system. In this case, transmitting coils are often also used to generate a drive force, for which purpose direct currents in many cases are also fed into the transmitting coils.

Advantageously, further storage elements provided on the primary part for providing a primary-side compensation current are completely dispensed with. In this case, neither energy storage elements that are connected in series nor energy storage elements that are connected in parallel to the transmitting coil are provided, such as capacitors or other storage elements. It is true that energy storage elements connected in parallel with the transmitting coil would not exclude the use of the present energy transmission system in one of the above-mentioned transport systems. However, in many cases the use of storage elements connected in parallel with transmitting coils is associated with great effort, especially because a large number of transmitting coils are provided in linear motor systems, so that in such a case a large number of storage elements would have to be provided overall.

In the course of inductive energy transmission, transmitted reactive power is likewise known to fluctuate back and forth between electrical storage elements and accordingly does not make a lasting contribution to the supply of secondary-side loads. The present invention takes this circumstance into account and therefore puts the focus on the transmitted active power as described. In this case, it has been shown that in order to increase transmitted active power, in particular the phase position between voltage dropping across the transmitting coil and current flowing through the transmitting coil is important. A maximum of transmitted active power is achieved if the aforementioned phase position assumes either zero or plus/minus 180 degrees. By introducing a secondary-side compensation current, this phase position is modified in such a way that the transmitted active power is increased compared to operation without a compensation current input. In this case, the (paradox) case can even occur that the apparent power transmitted in total is lower than in the case of operation of an inductive energy transmission system without the compensation current input according to the invention. A resonant coupling is not explicitly sought in this case and, in particular, does not constitute a necessary prerequisite for the use of the method according to the invention.

In other words, the secondary side supports the primary side with a voltage additionally induced in the main inductance of the energy transmission system during the charging of the main inductance. As a result, a voltage reserve is enabled in the supply unit, which voltage reserve is used to increase the transmitted active power. Because this voltage reserve that has been freed up and used to increase the transmitted active power is subsequently applied in phase with the current already flowing, the phase shift between the total voltage dropping across the transmitting coil and the current flowing through the transmitting coil changes in the manner described above.

In this context, it should be noted that the power fed with the secondary-side compensation current itself represents a mostly capacitive reactive power. For the present invention, it is decisive here that this mostly capacitive reactive power is deliberately transmitted from the secondary side to the primary side. In many cases, in addition to the change in the aforementioned phase relationship according to the invention, it is thereby achieved that reactive power occurring in the main inductance and often also in the primary-side leakage inductances no longer has to be provided exclusively by the supply unit. The advantageous side effect of an at least partial secondary-side compensation of a primary-side reactive power can in this case often contribute to a further improvement in the energy transmission.

In an advantageous manner, at least 50% of the reactive power of the main inductance is thereby provided on the secondary side, i.e., by the secondary part. However, at least 75% of the reactive power of the main inductance can preferably also be provided by the secondary part, or at least 90% of the reactive power of the main inductance can be provided by the secondary part. Most preferably, the entire reactive power of the main inductance is provided by the secondary part.

In an advantageous manner, less than 20% of the reactive power of the primary-side leakage inductances are always provided on the secondary side, i.e., by the secondary part. However, also less than 15% of the reactive power of the primary-side leakage inductances can be provided by the secondary part, or also less than 10% of the reactive power of the primary-side leakage inductances can be provided by the secondary part. As a result, within the scope of the invention, a substantially greater part of the reactive power of the main inductance is typically compensated than from the reactive power of the primary-side leakage inductances.

Within the scope of the present invention, it is thereby possible to dispense with primary-side reactive power compensation. Of course, even if the reactive power of the main inductance is not completely compensated by the secondary part, primary-side reactive power compensation can be dispensed with, for example if complete compensation of the reactive power of the main inductance is not sought. Advantageously, components for reactive power compensation, such as capacitors connected in parallel or in series with the primary-side transmitting coil, can thus be dispensed with on the primary part.

To implement the steps described above, as mentioned, a secondary-side compensation unit is used which outputs or receives a secondary-side compensation current to or from a receiving coil provided on the secondary part. Such a compensation unit can be implemented in various ways, for example in the form of a controllable AC power source, which itself is again supplied with a previously inductively transmitted power, or by capacitors having at least partially changeable capacitance. In this context, combinations of different approaches for introducing a secondary-side compensation current are also conceivable, in particular in order to combine the advantages of a plurality of different technologies. At this point it is worth noting that, although the compensation unit is provided according to the invention only on the secondary part, a precise modification in particular of the phase relations between primary-side variables is nevertheless possible.

The use of a compensation unit to be provided solely on the secondary part represents a significant advantage in particular in the implementation of efficient energy transmission in long stator linear motors. Such drive systems are typically characterized by a large number of drive coils provided on the primary part. In practice, these drive coils to form a drive force are often used simultaneously as transmitting coils for inductive energy transmission. This is usually done by superimposing electrical currents to form a drive force with currents that are higher-frequent than these for energy transmission. If only one individual compensation unit is required on the secondary side in such a system, and if a individual compensation unit does not have to be connected to each individual one of the many drive coils present on the primary side, as would be necessary within the context of the aforementioned resonant inductive coupling in the form of capacitors, an immense outlay of hardware, expense and design can often be avoided.

A further advantage of the concept according to the invention is its improved adaptability, compared with many conventional concepts, to changing transmission conditions, for example due to relative movements between the primary part and the secondary part. This advantage results on the one hand from the fact that for an adaptation, only the secondary-side compensation current has to be adapted, for example by varying the frequency and/or phase position and/or amplitude of the compensation current emitted by the compensation unit. In particular in the case of linear motor systems, the necessity of optimizing components on a large and extended primary part can lead to difficulties in practical implementation. On the other hand, in practical use, it is shown that the modification of a phase shift between two electrical variables of a primary part can be carried out substantially more robustly than a highly sensitive tuning of an excitation frequency to a, potentially rapidly, changing resonance frequency.

It should be noted at this point that while the object achieved by the present invention has its origin in the field of transport systems, and in particular of linear and planar motor systems, the method according to the invention can, however, generally be applied in inductive energy transmission systems.

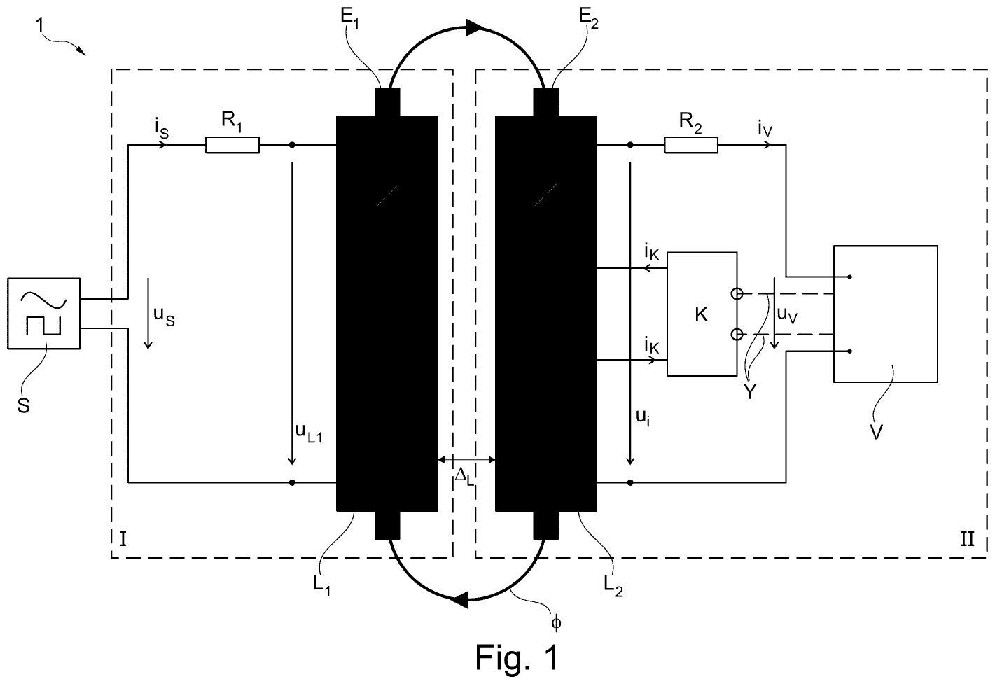

The present invention is described in greater detail below with reference to FIGS. 1 through 6, which show schematic and non-limiting advantageous embodiments of the invention by way of example. In the figures:

FIG. 1 shows an inductive energy transmission system,

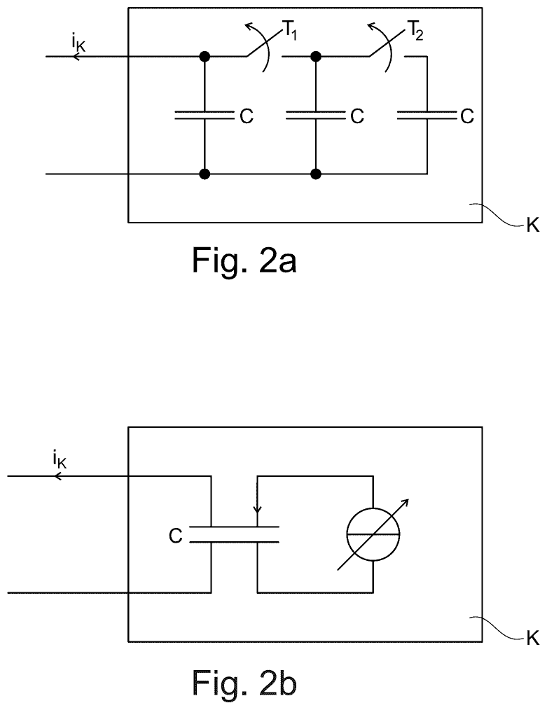

FIG. 2 shows possible embodiments of the compensation unit,

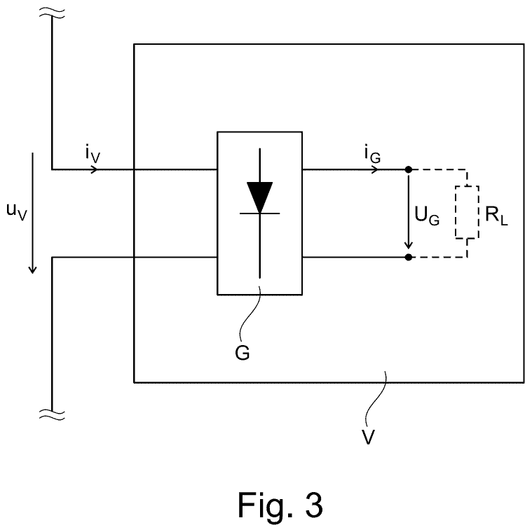

FIG. 3 shows a possible embodiment of a secondary-side load,

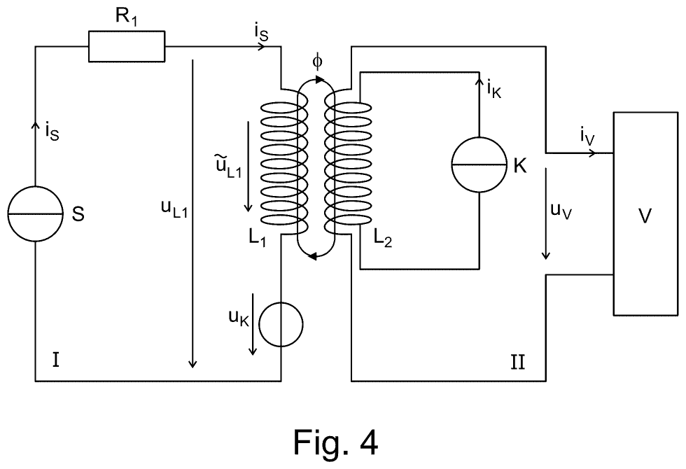

FIG. 4 shows a simplified abstraction of the inductive energy transmission system under consideration,

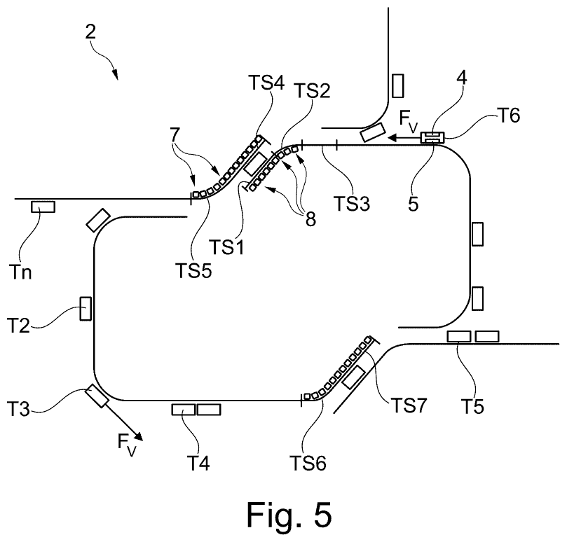

FIG. 5 shows a long stator linear motor system,

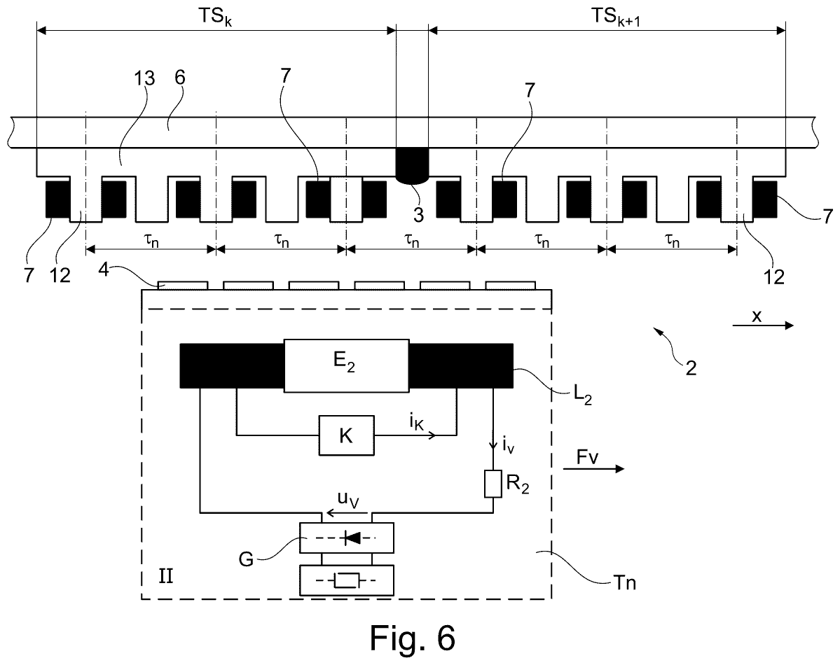

FIG. 6 shows the implementation of the inductive energy transmission system according to the invention in a long stator linear motor system.

FIG. 1 shows the basic structure of an inductive energy transmission system 1. A supply unit S outputs an electrical AC voltage uₛ to the part of the energy transmission system 1 located on the primary part I. Of primary importance here is the fact that the AC voltage uₛ is typically limited to an absolute value that, in particular, corresponds to the statements made at the outset regarding physical limits of power electronics used for the supply of power, and accordingly cannot be increased as desired in the course of an energy transmission. The frequency of the supply voltage us is also referred to below as an “excitation frequency.”

The supply voltage us subsequently causes a primary current i_{S} in the form of an alternating electrical current through the primary-side ohmic resistor R₁, which represents in concentrated form all of the ohmic resistors present on the primary part I, and the primary-side transmitting coil L₁. The ohmic resistance R₁ in the embodiment shown in FIG. 1 is switched between the transmitting coil L₁ and the supply unit S so that the ohmic resistance R₁ and the transmitting coil L₁ form a series connection.

The excitation frequency of the supply voltage uₛ determines the frequency of the primary current iₛ. The frequency of the primary current i_{S} therefore corresponds to the frequency of the supply voltage uₛ, which corresponds to the excitation frequency.

In the embodiment of the invention shown in FIG. 1, the primary-side ohmic resistor R₁ is provided between the supply unit S and the transmitting coil L₁. The primary-side ohmic resistor R₁ in this case is arranged in series with the transmitting coil L₁. Otherwise, on the primary part I between the transmitting coil L₁ and the supply unit S, no further electrical storage elements are provided such as capacitors, etc., and thus in particular no further electrical storage elements which, like the ohmic resistance R₁ are connected in series to the transmitting coil L₁. Because only the ohmic resistance R₁ is therefore connected between the supply unit S and the transmitting coil L₁, it is possible also to feed direct currents into the transmitting coil L₁, which is of decisive importance in particular in applications in transport systems.

Subsequently, the primary voltage drops across the primary coil u_{L1}. In order to improve the magnetic coupling between primary part I and secondary part II and/or reduce the air gap between them, an iron core E₁ can optionally be introduced into the transmitting coil L₁. Possible embodiments of an iron core E₁ can be provided, inter alia, by ferrites, powder cores or else by laminated structures, wherein instead of the term “iron core” the designation “magnetic core” is also customary. The same can be provided for the receiving coil L₂ on the secondary part II by the iron core E₂.

The primary current i_{S} in the next step leads to the formation of a first alternating magnetic field for energy transmission. This first alternating magnetic field contributes to the formation of a temporally variable magnetic flux Φ, which passes through the transmitting coil L₁ and the receiving coil L₂. The two coils L₁ and L₂ are separated by the air gap 41. According to the law of induction, an electrical voltage

$${u}_{i} = - {N}_{2} \cdot \frac{d}{d t} Φ$$

is induced in the receiving coil L₂, which, in turn, brings about a secondary current iᵥ on the part of the energy transmission system 1 located on the secondary part II. N₂ represents the number of turns of the receiving coil L₂. The current iᵥ further flows through the resistor R₂ which, like the resistor R₁, cumulatively represents the ohmic resistances of the secondary part, to at least one load V across which the voltage uᵥ drops. The at least one load V can stand here for a plurality of electronic devices, for example for a communication, measuring or regulating unit, or else for an accumulator or energy store which is charged with the transmitted energy.

The introduction according to the invention of a secondary-side compensation current i_{K} is performed in the shown case by the compensation unit K. The secondary-side compensation current i_{K} subsequently causes a second magnetic alternating field for active power optimization, which is superimposed on the first magnetic alternating field for energy transmission and thereby causes a resulting total magnetic alternating field. Due to the second alternating magnetic field for active power optimization, in the transmitting coil L₁, an additional AC voltage hereinafter referred to as a “primary-side compensation voltage,” u_{K} is induced. The primary-side compensation voltage u_{K} induced in the transmitting coil L₁ accordingly represents a further component of the total primary voltage u_{L1} dropping across the transmitting coil L₁ and thereby influences the phase shift between the primary voltage u_{L1} dropping across the transmitting coil L₁ and the primary current i_{S} flowing through the transmitting coil L₁. According to the invention, this phase shift is modified such that the resulting transmitted active power is increased.

In order to formulate the term for increasing transmitted active power more specifically, the term of the nominal or uncompensated active power P_{N} will be introduced first. The uncompensated active power P_{N} in this case describes that active power which would be achieved in a conventional operation of an inductive energy transmission system known from the prior art without introducing the compensation current i_{K} according to the invention. For this reason, nominal or non-compensated active power P_{N} is also referred to as active power without compensation, or active power without a changed phase shift. If the method according to the invention is applied, and according to the invention, a secondary-side compensation current i_{K} is fed into the receiving coil L₂, the transmitted active power is increased to a new active power referred to below as the resulting output active power P_{R}. According to the invention, the resulting output active power P_{R} represents an increase in the originally transmitted, uncompensated active power P_{N} of at least 10% to 100%, preferably 100% to 500%, and particularly preferably 500% to 5000% or more.

Because, in a preferred embodiment, the compensation unit K represents an active component which itself has to be supplied with electrical energy, in FIG. 1 a dashed connecting line Y from the load V to the compensation unit K, which if applicable enables an electrical supply of the compensation unit K. However, it is also possible for the compensation unit K to simultaneously perform the decoupling of transmitted energy and the function of a rectifier G. In such cases, the loads V can also be connected directly to the compensation unit K. This case can occur, for example, if the compensation unit K contains a controllable AC power source which can also assume the function of the rectifier G.

For the specific implementation of the compensation unit K, a plurality of concepts known from electronics can be used. The decisive criterion in the implementation of the compensation unit K is that a compensation current i_{K} that is appropriate with respect to phase, amplitude, and frequency can be output to the secondary-side part of the circuit of the energy transmission system 1. In this case, more complex implementation variants can be provided by controllable AC power sources. In contrast, less complex implementations are possible, for example, by means of capacitive storage elements connected in parallel to the receiving coil L₂, the capacitance of which being adapted during operation in order to always receive or deliver a desired secondary-side compensation current i_{K}.

Two implementation variants relating thereto are shown in FIG. 2, wherein FIG. 2a shows a connection of three capacitors C by means of two switches T₁ and T₂. Depending on the switch position, different capacitive resistances thus result. A number of further possible approaches exist for the implementation of variable capacitances. Mechanically variable capacitors, such as trimming or rotary capacitors which can be based on a wide variety of materials for dielectrics and electrode plates, and electrically variable capacitors such as capacitance diodes, are only examples here. A preferred embodiment of a variable capacitance is thereby provided by conventional capacitors such as electrostatic fixed capacitors in which an additive capacitive current is injected, which thus varies its capacitance. This implementation variant is shown in FIG. 2b using a variable current source connected in parallel to the capacitor C. In addition to capacitive storage elements, variable inductive storage elements for implementing a compensation unit K are also conceivable. Examples thereof are, inter alia, coils in which the positioning of an iron core is changed, or in which an additive voltage for the inductance change is applied analogously to the introduction of an additive capacitive current for capacitors.

In certain cases, it can prove particularly advantageous to connect capacitors and coils to one another in parallel or in series in a compensation unit K. Possible implementations of a compensation unit K further comprise, in particular, microprocessor-based hardware, microcontrollers, and integrated circuits (ASIC, FPGA, etc.), especially to enable the determination and ultimately correct introduction of a suitable compensation current ix for example by the control of a controllable AC power source. In the present case, for this purpose, analog circuits can also be mentioned as components of the compensation unit K, for example based on analog operational amplifier circuits. At this point, it should be mentioned that although the introduction of the compensation current i_{K} directly into the receiving coil L₂ represents a preferred embodiment of the present invention, it is certainly also possible to feed the compensation current i_{K} into another coil provided specifically for this purpose on the secondary part II and to generate the second alternating magnetic field according to the invention using this further coil.

A possible specific embodiment of a load V is shown in FIG. 3. Here, the rectifier G rectifies the transmitted alternating variables u_{V} and i_{V} into direct variables u_{G} and i_{G}, which can ultimately supply one or more electrical loads R_{L} provided on the secondary part II. In many cases, a voltage controller is further connected ahead of a load V.

In order to describe the basic principle of the present invention in more detail, FIG. 4 takes a further step of abstraction for the purpose of explanation, and the structure shown in FIG. 1 is shown in a greatly simplified manner. The supply unit S and the compensation unit K are shown as current sources, wherein voltage sources could also be used for both elements. For the following steps, it is particularly important that the current i_{S} injected by the supply unit does not or only hardly changes. Consideration of influences usually occurring in reality, such as parasitic elements, leakage currents, non-sinusoidal input voltages, etc., is dispensed with for the purpose of simplifying explanation as much as possible. However, the following embodiments can easily be expanded by such influences and are therefore not to be understood as limiting. Furthermore, it is assumed that the transmitting coil L₁ and the receiving coil L₂ have the same number of windings, whereby no transmission condition has to be taken into account. A generalization of the following statements by a transmission ratio is trivial for the person skilled in the art. In order to clearly highlight the influence the compensation current ix introduced on the secondary side, the voltage u_{K} induced thereby on the primary side I is represented with its own voltage source in series with the transmitting coil L₁. The primary voltage dropping across the transmitting coil L₁ is designated again with u_{L1}, wherein the primary voltage which would be set without applying the method according to the invention is referred to with ũ_{L1}. Starting from an operation without a secondary-side compensation current i_{K} and purely sinusoidal variables with a frequency f in Hz, the following can be written for the primary current i_{S} and the primary voltage u_{L1} without limiting the general applicability

$${i}_{S} ( t ) = \hat{I} \cdot sin ( 2 π f \cdot t + \frac{π}{180} {φ}_{i} )$$

$$and {u}_{L 1} ( t ) = {\tilde{u}}_{L 1} ( t ) = {\hat{U}}_{L} \cdot sin ( 2 π f \cdot t + \frac{π}{180} {φ}_{u} ) ,$$

wherein Î and Û_{L} represent the amplitudes of the two variables, the angles φᵢ; and φᵤ describe their phase positions in degrees, and the expression Δφ=φᵤ−φᵢ describes their phase shift relative to one another. As is known, purely reactive power is transferred from the transmitting coil L₁ to the receiving coil L₂ if Δφ=+90 degrees. If by contrast Δφ=0 or Δφ=180 degrees, wherein the latter is identical to Δφ=−180 degrees, the transmitted power becomes purely active power. If it is further taken into account that for the primary-side compensation voltage u_{K} induced by a secondary-side compensation current i_{K}, the expression

$${u}_{K} = {L}_{12} \frac{d}{d t} {i}_{K}$$

applies, wherein L₁₂ represents the coupled, mutual inductance of transmitting coil L₁ and receiving coil L₂, when there is a compensation current i_{K}

$${i}_{K} ( t ) = {\hat{I}}_{K} \cdot sin ( 2 π f \cdot t + \frac{π}{180} {φ}_{K} )$$

with the same frequency f, it is also possible to specify a sinusoidal description for the compensation voltage u_{K}, in particular as

$${u}_{K} ( t ) = {\hat{U}}_{K} \cdot sin ( 2 π f \cdot t + \frac{π}{180} {φ}_{uK} ) .$$

The amplitude Û_{K} and the phase shift φ_{uK} depend here on the amplitude Î_{K} and the phase shift φ_{K} in accordance with the relationship indicated above between u_{K} and i_{K}. The consequence of this is that, for the total voltage dropping across the transmitting coil, the following applies

$${u}_{L 1} ( t ) = {\tilde{u}}_{L 1} - ( t ) + {u}_{K} ( t ) = {\hat{U}}_{L} \cdot sin ( 2 π f \cdot t + \frac{π}{180} {φ}_{u} ) + {Û}_{K} \cdot sin ( 2 π f \cdot t + \frac{π}{180} {φ}_{u K} )$$

which can also be described as

$${u}_{L 1} ( t ) = {\hat{U}}_{L K} \cdot sin ( 2 π f \cdot t + \frac{π}{180} {φ}_{uLK} )$$

with the amplitude

$${\hat{U}}_{L K} = \sqrt{\begin{matrix}{[ {\hat{U}}_{L} \cdot cos ( \frac{π}{180} {φ}_{u} ) + {\hat{U}}_{K} \cdot cos ( \frac{π}{180} {φ}_{u K} ) ]}^{2} + [ {\hat{U}}_{L} \cdot sin ( \frac{π}{180} {φ}_{u} ) + \\ {{\hat{U}}_{K} \cdot sin ( \frac{π}{180} {φ}_{u K} ) ]}^{2}\end{matrix}}$$

and the phase position

$${φ}_{u L K} = arctan ( \frac{{\hat{U}}_{L} \cdot sin ( \frac{π}{180} {φ}_{u} ) + {\hat{U}}_{K} \cdot sin ( \frac{π}{180} {φ}_{u K} )}{{\hat{U}}_{L} \cdot cos ( \frac{π}{180} {φ}_{u} ) + {\hat{U}}_{K} \cdot cos ( \frac{π}{180} {φ}_{u K} )} )$$

The expressions for the amplitude Û_{LK} and phase position φ_{uLk} depend directly on the amplitude Û_{K} and the phase shift φ_{uK} and thus also on the compensation current i_{K}. It can be seen that the compensation current ix can on the one hand modify the phase position φ_{uLK} of the resulting primary voltage u_{L1} and, on the other hand, also the phase relationship Δφ between iₛ and the primary voltage u_{L1}. As a result, it is ultimately possible to directly influence how much active and how much reactive power is transmitted. It should be noted again at this point that the situation shown in FIG. 4 is a highly simplified representation in order to represent the basic principle of the method according to the invention.

The heart of the control task to be solved by the compensation unit K can accordingly be formulated as the determination of that secondary-side compensation current i_{K} by whose introduction the transmitted active power is maximized. To solve this core task, because the frequency is typically already predetermined by the primary-side voltage u_{S} or the primary-side current i_{S}, the amplitude and the phase position of the secondary-side compensation current i_{K} are preferably adapted.

In order to make a suitable choice for the amplitude and phase position of the secondary-side compensation current i_{K}, a wide variety of adaptation algorithms can be resorted to, for example a so-called “maximum power point tracker,” or else other controllers and/or (autonomous) learning mechanisms designed specifically for this purpose. In order to control whether, due to a specific choice or change of the amplitude or phase position of the secondary-side compensation current i_{K}, a desired change in the phase relationship Δφ between primary current i_{S} and primary voltage u_{L1} has also actually been achieved, it is possible to calculate, for example from measurement data of primary current i_{S} and primary voltage u_{L1}, the phase relationship thereof.

In order to be able to determine the required secondary-side compensation current i_{K} in the compensation unit K, the compensation unit K can be supplied with measurement data of relevant electrical variables, in particular of primary-side variables u_{L1} and/or i_{S}, but also of secondary-side variables, such as uᵢ, u_{V} or i_{V}. For this purpose, suitable measuring sensors, preferably on the secondary side II, but also on the primary side I, can be provided which transmit their measured values to the compensation unit K. In a preferred embodiment of the method according to the invention, the primary-side voltage u_{S} and the primary-side current i_{S} are measured and transmitted wirelessly, for example using a radio link, to the compensation unit K in order to avoid wiring between the primary part I and the secondary part II in particular when the method according to the invention is implemented in a transport system 2.

A particularly advantageous implementation of the method according to the invention also results from an indirect determination of primary-side voltage u_{S} and primary-side current i_{S}, wherein for example, from measurement data of induced voltage uᵢ and secondary-side current i_{V} detected on the secondary side II, the primary-side voltage u_{S} and the primary-side current i_{S} are calculated using an observer or a filter, whereby neither a radio connection nor wiring between the primary part I and secondary part II are necessary for implementing the method according to the invention.

In a further advantageous embodiment, it is also possible to dispense with primary-side electrical variables such as voltage u_{S} and current i_{S}. Instead, a DC voltage u_{G} which, as shown in FIG. 3, is preferably generated by a rectifier G arranged on the secondary side II, is used as a measure of the quality of the primary-side phase shift. This approach is based on the finding that, in the event of an increased output active power P_{R} transmitted to the load V and thus to the rectifier G, in many cases a higher DC voltage u_{G} is rectified by the rectifier G. A higher DC voltage u_{G} can accordingly represent a measure of an increased transmission of active power. It also applies here that the voltage u_{G} need not necessarily be measured directly, but can if applicable also be determined indirectly by means of filtering or observation.

Furthermore, despite an adaptation of a secondary-side compensation current i_{K} taking place on the secondary part II or of a compensation unit K, additionally adapting the excitation frequency of the input voltage u_{S} is of course not excluded. The excitation frequency can thus additionally be adapted to an electrical resonance frequency of the energy transmission system 1 that is set. However, in this approach, care must be taken that the associated changes in the primary-side electrical variables do not negatively affect the actual aim of the present invention, namely the adaptation of the phase shift between the primary-side variables of primary voltage u_{L1} and primary current i_{S}.

Within the scope of the present invention, however, it can also be advantageous to select the excitation frequency, i.e., the frequency of the primary electrical current i_{S} and/or the frequency of the supply voltage u_{S}, to be different from an electrical resonance frequency of the energy transmission system 1. The frequency of the primary electrical current i_{S} can deviate here by at least 1% of the value of the frequency of the primary electrical current i_{S}, or at least 5% of the value of the frequency of the primary electrical current i_{S}, or at least 10% of the value of the frequency of the primary electrical current i_{S}, or at least 50% of the value of the frequency of the primary electrical current i_{S} from an electrical resonance frequency of the energy transmission system 1.

Generally speaking, within the scope of the present invention, it can be advantageous to operate the energy transmission system 1 at a frequency apart from the electrical resonance frequencies of the energy transmission system 1.

In several applications of the present invention, it was found in this respect that a maximum of active power transmitted from the primary side I to the secondary side II is achieved if the excitation frequency and thus the frequency of the primary electrical current i_{S} deviates by more than 1%, or by more than 3%, or by more than 5% of the value of the frequency of the primary electrical current i_{S} from the lowest resonance frequency of the energy transmission system 1 that is different from zero. In these cases, the energy transmission system 1 is deliberately operated next to its resonance frequencies and thus outside its resonant points.

The energy transmission system 1 is advantageously operated at a frequency which is, for example, 1% or 3% or 5% higher than the lowest electrical resonance frequency of the energy transmission system 1.

As mentioned at the outset, electromagnetic transport systems 2 such as linear or planar motor systems are a preferred field of application of the method according to the invention for inductive energy transmission. To go into further detail about the special features given there in the implementation of the invention, FIG. 5 initially shows a possible design of a transport system 2. The transport system 2 consists of a number of transport segments TSk (k here is an index which stands for all available transport segments TS1, TS2, TS3, . . . ), of which, for reasons of clarity, only the transport segments TS1. TS7 are denoted by way of example. The transport segments TSk form different route sections, for example a straight line, curves with different angles and radii, switches, etc., and can be assembled very flexibly in order to form the transport path of the transport system 2. Together, the transport segments TSk thus form a transport path along which the transport units Tn (n is an index that represents all existing transport units T1, T2, T3, T4, . . . ) can be moved. This modular structure enables a very flexible design of the transport system 2. The transport segments TSk are usually arranged on a stationary support structure 6 (not shown in FIG. 5).

In the present case, the transport system 2 is designed as a long stator linear motor, wherein the stator segments TSk each form a portion of a long stator of a long stator linear motor in a manner known per se. Along the long stator of the transport segments TSk, a plurality of stationary electrical drive coils 7, 8 forming the stator are therefore arranged in the longitudinal direction in a known manner (indicated in FIG. 5 only for the transport segments TS1, TS2, TS4, TS5, TS6, TS7 for reasons of clarity), through which a drive current flows and which can interact with the drive magnets 4, 5 on the transport units T1. . . . Tn (indicated in FIG. 5 only for the transport unit T6 for reasons of clarity) in order to, in a known manner, generate a drive force F_{V} for moving the transport unit Tn. Typically, the electric drive current also comprises a direct component, i.e., a direct current.

In addition to transport systems 2 designed as long stator linear motors, transport systems implemented as planar motors represent a further important application of the method according to the invention. A planar motor essentially has a stator forming a transport plane in which one or more transport units can be moved at least two-dimensionally. With regard to the method according to the invention, the transport units function as secondary parts II. The stator is generally constructed from one or more transport segments, which assume the role of primary parts I. In order to move the transport units in the transport plane, a driving force acting on the transport unit is generated by a magnetic field of the stator (of the transport segment(s)) interacting with a magnetic field of the transport unit. In order to effect a movement of the transport unit in a specific movement direction, at least one of the magnetic fields, i.e., that of the stator and/or that of the transport unit, must be temporally changeable in order to follow the movement of the transport unit. In most cases, however, only one magnetic field, usually that on the stator, is temporally changeable and the respective other magnetic field (that on the transport unit) is usually constant, i.e., it is not temporally changeable.

How the method for inductive energy transmission of the present invention can be implemented in a transport system 2 is shown in detail in FIG. 6. FIG. 6 shows a detailed view of two adjacent straight transport segments TSK, TSk+1. The transport segments TSk, TSk+1 are arranged here to form a transport path on a stationary support structure 6, or themselves form a part of the stationary support structure 6. A magnetically conductive and elastic material 3 can preferably be attached between the transport segments TSK, TSK+1. The drive coils 7 of the long stator linear motor are arranged on the transport segments TSk or TSk+1. The drive magnets 4 are arranged on the transport unit Tn. A drive magnet 4 can be designed as an electromagnet (excitation coils) and/or as a permanent magnet. The drive coils 7 are preferably arranged on teeth 12 of a ferromagnetic core 13 (for example an iron lamination stack). However, the drive coils 7 can of course also be designed without a core. Of course, guide elements, such as rollers, wheels, sliding surfaces, guide magnets, etc., can also be provided on the transport unit Tn (not shown here for reasons of clarity) in order to guide and hold the transport unit Tn along the transport path 20, in particular also at a standstill. In order to generate a magnetic flux which is as uniform as possible in the longitudinal direction x of the transport path 20, i.e., in the direction of movement of the transport unit Tn, and consequently of a uniform drive force Fv, the drive coils 7, when viewed in the longitudinal direction (or direction of movement) x, are typically arranged at a constant distance, usually referred to as a slot pitch τₙ, from one another on the transport segments TSK, TSk+1.

As FIG. 6 shows, the transport units Tn with regard to the method according to the invention assume the role of the secondary parts II for inductive energy transmission and can be designed analogously to the structure shown in FIG. 1. The function of the primary part I is assumed by the extended long stator, where, as mentioned, the drive coils 7 can additionally be used for energy transmission by superimposing a higher-frequency current for energy transmission of a low-frequency drive current to generate a drive force Fv. In order to not unnecessarily energize drive coils 7 which are far away from a transport unit Tn and therefore cannot make any contribution to energy transmission, only drive coils in the immediate vicinity of a transport unit Tn are usually energized. It should be noted here that, for energy transmission, also a plurality of adjacent drive coils 7 can work together as transmitting coils L1.

Several special features associated with the transport system 2 would additionally highlight some of the advantages of the method according to the invention already mentioned above. Thus, in drafting and in designing transport systems 2, it is often desired to select the groove pitch τₙ to be as small as possible in order to be able to realize the most precise possible positioning of a transport unit Tn. When the groove pitch τₙ is reduced, the drive coils 7 move closer together, which in particular leads to an increase of primary-side leakage inductances which entail an increased reactive power requirement with all the negative consequences already mentioned with regard to inductive energy transmission. Because the supply voltage u_{S} is limited in transport systems 2 and leakage inductances are comparatively large, in such cases, virtually the entire available voltage us is often needed for driving the leakage fluxes. However, by means of the method according to the invention, it is also possible in such cases, despite partially considerable primary-side reactive power and other limitations such as limited supply voltages u_{S} or limited primary currents i_{S}, to also transmit active power to an extent by which it is nevertheless possible to supply one or more secondary-side loads sufficiently with electrical energy.

A further point that comes to light to a particular degree in the case of transport systems 2 is often the need for adaptation to changes in the transmission conditions, which in this context result from the relative movements between primary part I and secondary part II that are present in principle. If a single secondary-side compensation unit K is already sufficient to realize efficient energy transmission as described, an adaptation can be carried out comparatively easily, because specifically only the compensation unit K or the compensation current ix provided thereby has to be adapted to changing transmission conditions. Moreover, an immense hardware outlay is avoided which would be associated with a primary-side installation of a compensation unit K for each drive coil 7.

The aforementioned extension of the method according to the invention by a simultaneous adaptation of the excitation frequency to a resulting electrical resonance frequency of the energy transmission system 1 can represent a valuable extension possibility in the case of long stator linear motors and planetary motors. Because the transmission conditions can continuously change due to movements between the primary I and the secondary part II, a further improvement in the energy transmission can be achieved by an additional alignment between the excitation frequency and a resonance frequency of the energy transmission system 1.

1-10. (canceled)

11. A method for inductive energy transmission between a primary part and a secondary part, the primary part and the secondary part being parts of a transport system, preferably of a linear motor system, a planar motor system or a magnetic levitation railroad system, the primary part corresponding to a stationary part of the transport system and the secondary part corresponding to a part of the transport system that is movable relative thereto, the secondary part being moved relative to the primary part, a primary electrical current being fed from a supply unit into a transmitting coil arranged on the primary part in order to create a first alternating magnetic field for energy transmission, whereby an electrical AC voltage is induced in a receiving coil arranged on the secondary part, which AC voltage causes an electrical secondary current on the secondary part and thus a power flow comprising an uncompensated active power to at least one load connected to the receiving coil, wherein a secondary-side compensation current is fed into a secondary-side coil by a compensation unit arranged on the secondary part which is moved relative to the primary part, in that a second alternating magnetic field is generated by the secondary-side compensation current in the secondary-side compensation current, which second alternating magnetic field is superimposed on the first alternating magnetic field for energy transmission and induces a primary-side compensation voltage in the transmitting coil, in that a phase shift between the electrical primary voltage dropping across the transmitting coil and the primary current flowing through the transmitting coil is changed by the primary-side compensation voltage induced in the transmitting coil in such a way that a resulting output active power, which is transmitted by the primary part after the change of the phase shift on the at least on load connected to the receiving coil is increased compared to the uncompensated active power without a changed phase shift and in that no primary-side compensation current, which changes the phase shift between the electrical primary voltage dropping across the transmitting coil and the primary current flowing through the transmitting coil and which is provided by an electrical storage element connected in series to the transmitting coil and between the transmitting coil and the supply unit, is fed into the transmitting coil arranged on the primary part.

12. The method according to claim 11, wherein the phase shift between the electrical primary voltage dropping across the transmitting coil and the primary current flowing through the transmitting coil is changed only by the primary-side compensation voltage caused by the secondary-side compensation current and induced in the transmitting coil.

13. The method according to claim 11, wherein an electrical drive current is introduced into the transmitting coil in addition to the primary current in order to create a first alternating magnetic field by means of which the drive force acting on the secondary part is generated.

14. The method according to claim 13, wherein a direct current is introduced into the transmitting coil with the electrical drive current.

15. The method according to claim 11, wherein the electrical primary voltage dropping across the transmitting coil and the primary current flowing through the transmitting coil are determined and transmitted to the compensation unit, in that from the transmitted data of primary voltage and primary current, the phase shift between primary voltage and primary current is determined, and in that on the basis of the phase shift between primary voltage and primary current, the secondary-side compensation current is changed in order to bring the phase shift between primary voltage and primary current closer to zero or closer to 180 degrees.

16. The method according to claim 11, wherein the secondary-side compensation current fed by the compensation unit into the receiving coil is adapted to changes in the transmission conditions between the transmitting coil and the receiving coil which are caused in particular by aging, temperature influence or wear of the transmitting coil and receiving coil, the supply unit or the at least one load and/or by changes in the relative position between primary part and secondary part.

17. The method according to claim 11, wherein the frequency of the primary current, which is fed from the supply unit into the transmitting coil arranged on the primary part is adjusted to conform to an arising resonance frequency of a resonant electrical circuit, which is formed by at least the transmitting coil, the receiving coil, the compensation unit and the at least one load.

18. A device for inductive energy transmission, comprising a primary part and a secondary part, the primary part and the secondary part being parts of a transport system, preferably a linear motor system, a planar motor system, or a magnetic levitation railroad system, and the primary part corresponding to a stationary part of the transport system and the secondary part corresponding to a part of the transport system that is movable relative thereto, a supply unit being provided on the primary part in order to feed an electrical primary current into a transmitting coil arranged on the primary part in order to create a first alternating magnetic field for energy transmission, a receiving coil and at least one load which can be connected electrically to the receiving coil being arranged on the secondary part, an electrical AC voltage being induced in the receiving coil by the first alternating magnetic field for energy transmission, which AC voltage causes an AC current on the secondary part and thus a power flow comprising an uncompensated active power to the at least one load which can be connected to the receiving coil, wherein at least one compensation unit is arranged on the secondary part, which compensation unit is designed to feed a secondary-side compensation current into a secondary-side coil and thereby generate a second alternating magnetic field which is superimposed on the first alternating magnetic alternating field for energy transmission and which induces a primary-side compensation voltage in the transmitting coil, a phase shift between the primary voltage dropping across the transmitting coil and the primary current flowing through the transmitting coil being changed by the primary-side compensation voltage induced in the transmitting coil such that the resulting output active power, which is transmitted from the primary part, after the change of the phase shift between the primary voltage dropping across the transmitting coil and the primary current flowing through the transmitting coil to the at least one load which can be connected to the receiving coil, is increased compared to the uncompensated active power without a changed phase shift, and in that no electrical storage elements connected in series with the transmitting coil are provided on the primary part between the transmitting coil and the supply unit in order to feed a primary-side compensation current for changing the phase shift between the electrical primary voltage dropping across the transmitting coil and the primary current flowing through the transmitting coil into the transmitting coil.

19. The device according to claim 18, wherein the at least one compensation unit comprises at least one electrically variable capacitor, and/or at least one electrically variable coil, and/or an interconnection of at least one electrically variable capacitor and one electrically variable coil.
